(19) United States
(12) Patent Application Publication
(10) Pub. No.: US 2023/0273907 A1
(43) Pub. Date: Aug. 31, 2023

(54) MANAGING TIME SERIES DATABASES USING WORKLOAD MODELS

(71) Applicant: International Business Machines Corporation, Armonk, NY (US)

(72) Inventors: Peng Hui Jiang, Beijing (CN); Sheng Yan Sun, Beijing (CN); Meng Wan, Beijing (CN); Hong Mei Zhang, Beijing (CN)

(21) Appl. No.: 17/586,897

(22) Filed: Jan. 28, 2022

(51) Int. Cl. G06F 16/21; G06F 9/48

(52) U.S. Cl. CPC G06F 16/217; G06F 9/4881

(57) ABSTRACT

A method of managing time series data workload requests includes receiving a workload job request from a user in a multi-tenant network, the request specifying a plurality of workloads, each workload including time series data configured to be stored in a time series database (TSDB), inputting workload information to a workload model that is specific to the user, and classifying each workload according to the workload model, the workload model configured to classify each workload based on a plurality of parameters, the plurality of parameters including at least a workload type and an amount of storage associated with each workload. The method also includes assigning each workload of the plurality of workloads into one or more workload groups based on the classifying, and executing each workload according to the workload type and the storage size.

### BACKGROUND

Embodiments of the present invention relate to database management, and more specifically, to a method and apparatus for managing time series databases and workloads.

With the development of computer, data communication and real-time monitoring technologies, time series databases have been widely applied to many aspects such as device monitoring, production line management and financial analysis. A time sequence refers to a set of measured values that are arranged in temporal order, and a time series database refers to a database for storing these measured values. Examples of time series data include server metrics, performance monitoring data, network data, sensor data, events, clicks, trades in a market, and various types of analytics data.

Large amounts of data is typically stored in and accessed from a time series database. In addition, there may be significant similarities between different time series data. This can present a challenge, for example, in multi-tenant cloud networks and other networks in which a large number of customers are accessing a time series database.

### SUMMARY

An embodiment of a method of managing time series data workload requests includes receiving a workload job request from a user in a multi-tenant network, the request specifying a plurality of workloads, each workload including time series data configured to be stored in a time series database (TSDB), inputting workload information to a workload model that is specific to the user, and classifying each workload according to the workload model, the workload model configured to classify each workload based on a plurality of parameters, the plurality of parameters including at least a workload type and an amount of storage associated with each workload. The method also includes assigning each workload of the plurality of workloads into one or more workload groups based on the classifying, and executing each workload according to the workload type and the storage size.

In addition to one or more of the features described above or below, or as an alternative, in further embodiments the workload model is configured to classify each workload based on a charge amount associated with each workload.

In addition to one or more of the features described above or below, or as an alternative, in further embodiments the workload model is configured to classify each workload by defining a vector space, constructing a workload type vector and a storage size vector, and calculating a vector angle.

In addition to one or more of the features described above or below, or as an alternative, in further embodiments the method includes monitoring stored time series data during execution of each workload, calculating a delta value based on changes in the stored time series data, and predicting time series data values for a future time window.

In addition to one or more of the features described above or below, or as an alternative, in further embodiments the method includes automatically adjusting the time window based on the predicting.

In addition to one or more of the features described above or below, or as an alternative, in further embodiments the method includes inputting the predicted data values to a revision model, the revision model configured to calculate a variance between one or more parameters of the stored time series data and one or more parameters of the predicted data values.

In addition to one or more of the features described above or below, or as an alternative, in further embodiments the method includes adjusting the workload model based on the variance.

In addition to one or more of the features described above or below, or as an alternative, in further embodiments the method includes incorporating the workload groups into a federated model associated with a plurality of tenants in the multi-tenant network.

An embodiment of an apparatus for managing time series data workload requests includes a computer processor that has a processing unit including a processor configured to receive a workload job request from a user in a multi-tenant network, the request specifying a plurality of workloads, each workload including time series data configured to be stored in a time series database (TSDB), and a workload model. The workload model is specific to the user and is configured to receive workload information, classify each workload based on a plurality of parameters, the plurality of parameters including at least a workload type and an amount of storage associated with each workload, and assign each workload of the plurality of workloads into one or more workload groups based on the classifying. The processor is configured to execute each workload according to the workload type and the storage size.

In addition to one or more of the features described above or below, or as an alternative, in further embodiments the workload model is configured to classify each workload based on a charge amount associated with each workload.

In addition to one or more of the features described above or below, or as an alternative, in further embodiments the workload model is configured to classify each workload by defining a vector space, constructing a workload type vector and a storage size vector, and calculating a vector angle.

In addition to one or more of the features described above or below, or as an alternative, in further embodiments the processor is configured to monitor stored time series data during execution of each workload, calculate a delta value based on changes in the stored time series data, and predict time series data values for a future time window.

In addition to one or more of the features described above or below, or as an alternative, in further embodiments the processor is configured automatically adjust the time window based on the predicting.

In addition to one or more of the features described above or below, or as an alternative, in further embodiments the processor is configured to input the predicted data values to a revision model, the revision model configured to calculate a variance between one or more parameters of the stored time series data and one or more parameters of the predicted data values.

In addition to one or more of the features described above or below, or as an alternative, in further embodiments the processor is configured to adjust the workload model based on the variance.

In addition to one or more of the features described above or below, or as an alternative, in further embodiments the processor is configured to incorporate the workload groups into a federated model associated with a plurality of tenants in the multi-tenant network.

An embodiment of a computer program product includes a storage medium readable by one or more processing circuits, the storage medium storing instructions executable by the one or more processing circuits to perform a method. The method includes receiving a workload job request from a user in a multi-tenant network, the request specifying a plurality of workloads, each workload including time series data configured to be stored in a time series database (TSDB), inputting workload information to a workload model that is specific to the user, and classifying each workload according to the workload model, the workload model configured to classify each workload based on a plurality of parameters, the plurality of parameters including at least a workload type and an amount of storage associated with each workload. The method also includes assigning each workload of the plurality of workloads into one or more workload groups based on the classifying, and executing each workload according to the workload type and the storage size.

In addition to one or more of the features described above or below, or as an alternative, in further embodiments the workload model is configured to classify each workload based on a charge amount associated with each workload.

In addition to one or more of the features described above or below, or as an alternative, in further embodiments the workload model is configured to classify each workload by defining a vector space, constructing a workload type vector and a storage size vector, and calculating a vector angle.

In addition to one or more of the features described above or below, or as an alternative, in further embodiments the method includes monitoring stored time series data during execution of each workload, calculating a delta value based on changes in the stored time series data, predicting time series data values for a future time window, and automatically adjusting the time window based on the predicting.

### BRIEF DESCRIPTION OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 illustrates an embodiment of a computer network, which is applicable to implement the embodiments of the present invention;

FIG. 2 depicts an embodiment of a server configured to manage aspects of a time series database, which is applicable to implement the embodiments of the present invention;

FIG. 3 depicts an example of aspects of a workload model;

FIG. 4 is a block diagram depicting an embodiment of a method of managing a time series database and workload requests;

FIG. 5 depicts a cloud computing environment according to one or more embodiments of the present invention;

FIG. 6 depicts abstraction model layers according to one or more embodiments of the present invention; and

FIG. 7 illustrates a system for managing time series database workload requests according to one or more embodiments of the present invention.

### DETAILED DESCRIPTION

Systems, devices and methods are provided for managing a time series database, and/or managing workload requests. An embodiment of the present invention includes a system that is configured to manage workload requests from users (tenants) of a multi-tenant cloud or other network based on constructing and/or updating a workload model that is specific to each user of the tenant requesting access to the time series database. The workload model defines various workload types and classifies workloads according to properties such as workload type, record type, storage size and or charge amount. The system may also be configured to perform periodic revisions of the workload model via a revision model, in order to update the workload model to accommodate new workload requests and/or changes in stored time series data.

Embodiments of the present invention described herein provide a number of advantages and technical effects. For example, one or more embodiments are capable of significantly reducing storage size by grouping workloads with similar storage needs and/or charges, as well as improving input/output throughput. In addition, one or more embodiments allow for multiple tenants to share time series data.

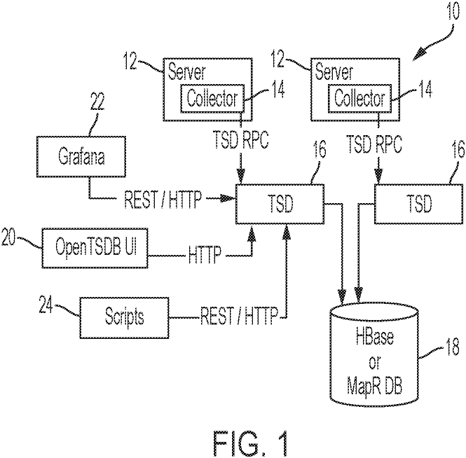

FIG. 1 depicts an example of components of a multi-tenant cloud architecture 10 in accordance with one or more embodiments of the present invention. Generally, the architecture includes multiple users or devices (tenants) that share a database and also share instances of software stored in a server or other processing system. In this example, the architecture 10 includes a plurality of servers 12 (or other processing devices or systems), each having a collection unit 14 for acquiring metrics and/or other time series data from various tenants. For example, each server 12 collects measurement data from tenants and transmits the measurement data to a time series daemon (TSD) 16. A TSDB is a software system that is optimized for storing and providing time series data. Time series data includes, for example, pairs of timestamps and data values. Each TSD 16 is configured to inspect received data, extract time series data therefrom, and send the time series data to a time series database (TSDB) 18 for storage. The TSDB 18 may include a database control processing device (e.g., HBase or MapR). Communication between the servers 12 and the TSDs 16 may be accomplished using a remote procedure call (RPC) protocol or other suitable protocol.

Tenants can communicate with the database 18 via any of various user interfaces (IUs) and TSDs 16. For example, a UI 20 such as an Open TSDB UI, can be used to retrieve and view data. A UI may include additional data analysis capabilities. For example, a UI 22 such as Grafana™ can provide various analysis and visualization tools. On or more tenants can use a script module 24 to script analyses of data stored in the database.

In response to requests from a tenant and user interface, the TSDB 18 (via a control processor) retrieves requested data and returns the data to the requesting tenant. The data may be summarized or aggregated if requested. The data is collected as time series data that is stored in the shared TSDB 18.

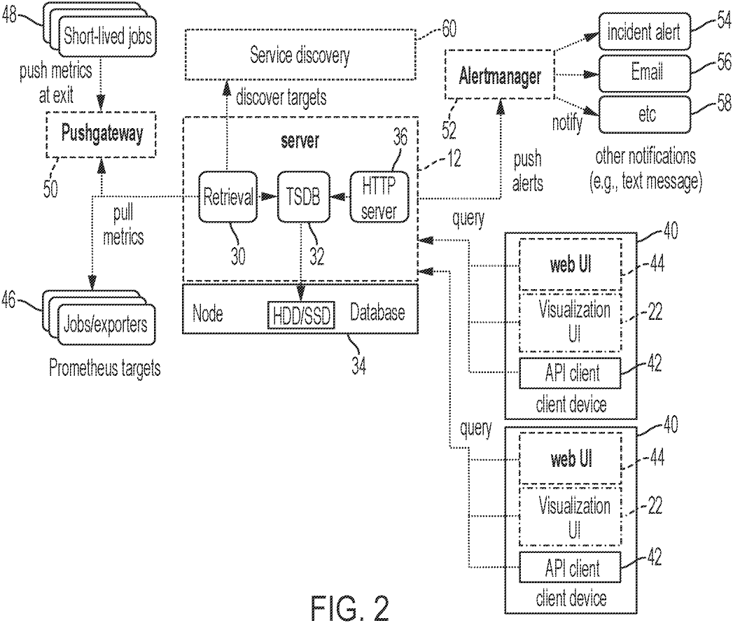

FIG. 2 depicts an example of part of the architecture 10, including an example of the server 12 configured to communicate with various tenants, in accordance with one or more embodiments of the present invention. The server 12 includes various processing modules, such as a retrieval module 30 for retrieving metrics and other time series data from various tenants, a TSDB management module 32 (e.g., HBase™) for storing to and retrieving from a TSDB 34, and a network communication module 36 (e.g., a HTTP server). For example, the module 32 is configured to scrape time series data from received data (e.g., workload jobs) such as metrics and other analytics data.

A plurality of tenants share access to the server 12. Examples of tenants include tenant devices 40, which are configured to communicate with the server 12 and/or TSDB 34, for example, to transmit data for storage in the TSDB 34 and/or query the TSDB 34. Each tenant may include components such as an API client or other communication module 42 for facilitating transfer of data between the device 40 and the server 12, a web-based UI 44 and/or the visualization UI 22.

The server 12 is able to pull metrics from the TSDB 34, e.g., as jobs 46, and is also able to transmit and receive metrics related to short-lived jobs 48 via a push gateway 50. The server 12 may also include or be connected to an alert manager 52 that is configured to generate notification messages such as incident alerts 54, email alerts 56 and other types of notifications 58. The server 12 may also include a service discovery system 60 for containerized applications.

A processing device or system, such as the server 12, is configured to use a multi-tenancy workload model that is specific to each client or user of a TSDB, such as the TSDB 34. The workload model allows the system to track the workload needs for each user and group users and workload according to similarities, which reduces the storage needed for each user and improves throughput (I/O).

A “workload” typically includes a workload data set (i.e., a set of time series data) and a workload query set for executing operations such as storage, updates and others. Time series data, which typically includes a series of values and associated time stamps, may be stored in the database, and inserted or added to existing data records in the TSDB.

The workload model includes various workload parameters, include workload type, data type, storage size, charge amount, delta and/or others. In an embodiment, each workload type parameter corresponds to a respective TSDB data type or workload type. The following workload types may be defined by various data types in the workload model, examples of which include:

In-memory data for value alerting: data stored in the TSDB, the values of which are compared to input data. Value alerts may be triggered based on the value of an input data point or series segment corresponding to in-memory data.

In-memory for trend alerting: data stored in the TSDB and having trends that may be compared to input data to trigger trend alerts.

In-memory for applications and dashboards: data stored in the TSDB that is used by applications that perform actions based on data values, and/or is used by dashboards to update displays.

Fast access: data stored in the TSDB for which quick access is desired. This type of data may be used, for example, for real-time analytics (e.g., business intelligence (BI) systems, ad-hoc queries, ML algorithms, AI software, and reporting tools). This type of data may also be used for machine learning (ML) and artificial intelligence (AI) algorithms.

High concurrency: data that represents the most recent records, which may be accessed by multiple users simultaneously.

High capacity: large sets of TSBD data accessed by a user, for example, for scanning and comparing stored data with input data.
Standard SQL functions and
Custom time-series functions.

In addition to workload type, the workload model may also include additional parameters such as record type, delta change, storage size and charge amount. The record type may be identified or classified based on a label associated with a given record, which can help group users and record types to decrease training cost. Examples of record type include raw data, aggregated data, virtual data, online transaction processing (OLTP) data, online analytical processing (OLAP) data, and others. The delta change refers to a change in data values over time. Storage size refers to an amount of storage requested or needed for a given workload.

In an embodiment of the present invention, the workload model includes a time series prediction method to predict future time series data and estimate the storage size. In an embodiment, a time series method is used for the prediction, although any suitable prediction or forecasting method can be used.

For example, a weighted moving average method may be used, which is represented by the following equation:

$${\hat{y}}_{i} = \frac{1}{\text{m}} \left({\text{w}}_{1} * {\text{y}}_{\text{i-} 1} + {\text{w}}_{2} * {\text{y}}_{\text{i-} 2} + {\text{w}}_{3} * {\text{y}}_{\text{i-} 3} … … + {\text{w}}_{\text{m}} * {\text{y}}_{\text{i-m}}\right)$$

where ŷ₁ is a time series, m is a number of observations (data points), i is a time increment, and yᵢ₋₁ to y₁ᵢ₋ₘ are time series data values. Weights w₁-wₘ may be assigned, which add up to one, and may be assigned so that higher weights are given to more recent data.

The above time series may be used to predict future data values and also predict the storage need for a workload.

The workload model is specific to a given user, and in an embodiment, classifies workloads for that user by a vector angle method. The vector angle method includes constructing a vector for each of one or more parameters, such as workload type, record type, delta change, storage size and/or charge amount.

For example, for a job requested by a user, each workload in the job is inspected to determine workload type and record type. Storage size is determined, for example, based on the prediction discussed above. If desired, delta encoding may be performed to calculate a delta value. Charge amount may be determined based on information regarding prices charged by an entity providing TSDB services (e.g., a cloud service).

In an embodiment, each workload is used to define a vector space in which parameter values are plotted to define parameter vectors. The parameter vectors can then be compared to define vector angles between parameters.

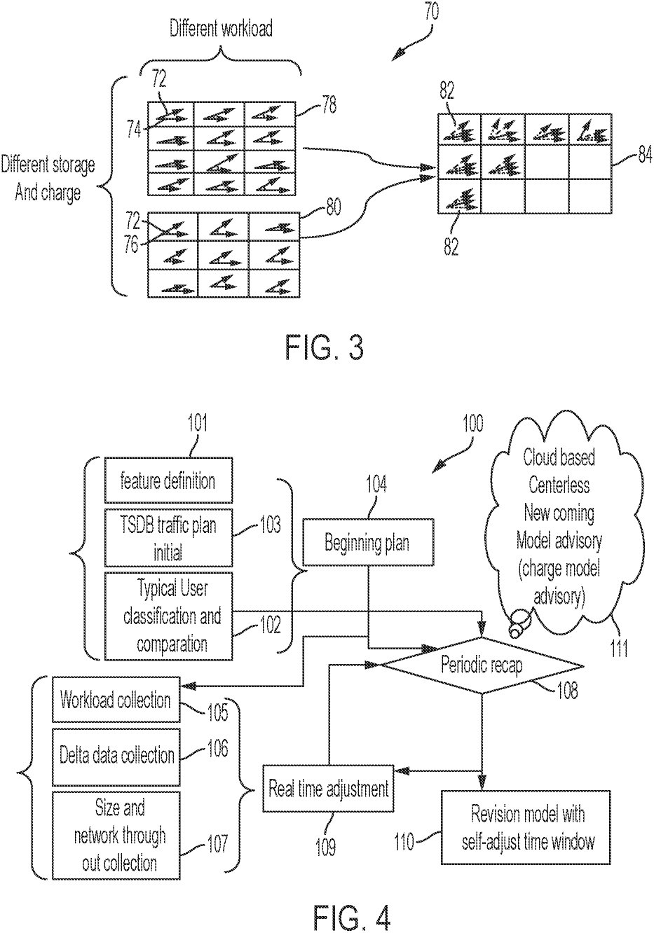

An example of a workload model in accordance with one or more embodiments of the present invention is discussed with reference to FIG. 3. A vector space is defined using received workloads, and for each workload, a workload type vector 72 (including a value for, e.g., CPU-intensive, storage-intensive, network-intensive, etc.), a storage size vector 74 and a charge amount vector 76 is calculated. Storage sizes may correspond to cache sizes, block sizes and others, and charge amount may be provided based on traffic, network usage, pre-arranged periodic charges and others. The vectors are compared and analyzed to determine an angle therebetween, referred to as a vector angle. Exemplary vector angles between workload type vectors 72 and storage size vectors 74 are shown in a matrix 78. Exemplary vector angles between workload type vectors 72 and charge amount vectors 76 are shown in a matrix 80.

Similar vector angles (e.g., angles below a threshold or within a threshold range) may be clustered. For example, as shown in FIG. 3, vector angles that have similar values (e.g., within a selected range of one another) are grouped into clusters 82 that represent similar workloads, as shown in matrix 84.

In an embodiment, the system uses a revision model that allows for periodic revisions of the workload model. Revisions may be performed as workload execution progresses, as data is updated, and as new workloads and/or jobs are received from a tenant.

The revision model is used to predict revisions to the workload model according to one or more future time periods or time windows. A time window may be pre-selected as one or more fixed time windows. For example, for long term data (e.g., data collected over months or years), various fixed time windows can be selected, such as time windows for predicting year-to-year growth, or time windows for specific periods.

In an embodiment, the revision model is applied by calculating the variance of one or more workload model parameters for a give time window, also referred to as a revision period, which is used to estimate expected values. For example, time series data is observed in real time and the delta of the time series data is collected. The variance of the time series data and/or the delta may be calculated based on the following equation:

$${σ}_{0}^{2} = \frac{1}{N} {\sum }_{\text{λ} ∈ {A}^{1}} {\left|{\tilde{X}}_{λ}\right|}^{2} ,$$

Where N refers to the number of time series data points or observations (or delta values), and X̅₁ is the mean of the data points or observations.

Based on the variance, the workload model is adjusted or updated by calculating updated values for the vector angles as described above.

In an embodiment, one or more of the time windows are automatically selected by training a time window self-adjust model. The model can be trained by collecting training data in the form of storage size, delta and workload data collected over time, and determining time windows for various types of workloads and/or users. Training the model includes, for example, receiving incoming traffic, updating the delta, and calculating the variance. The variance may be between the updated delta and a previously calculated delta, and/or between predicted data and received data. If the variance is at or above a selected variance threshold, the variance is fed back to the model for time window updating.

FIG. 4 illustrates aspects of an embodiment of a computer-implemented method 100 of managing time series databases and/or workload requests. The method 100 may be performed by a processor or processors, such as processing components of the server 12 and/or the TSDB 34, but is not so limited. It is noted that aspects of the method 100 may be performed by any suitable processing device or system.

The method 100 includes a plurality of stages or steps represented by blocks 101-111, all of which can be performed sequentially. However, in some embodiments, one or more of the stages can be performed in a different order than that shown or fewer than the stages shown may be performed.

At block 101, features of the workload model, such as workload types, storage sizes and charge amounts, are selected or defined as discussed above.

At block 102, for a given user, a user or tenant is classified according to a user classification model, which allows for tenants of similar types to be grouped according to similarities. Tenants may be grouped by, for example, workload type, record type and data volume (volume of data in a workload requested by the user, and/or change in volume). The classification model may be a classifier, SVM and/or other machine learning or artificial intelligence model.

At block 103, the processor determines an initial traffic plan, which may be defined by the user. The traffic plan specifies, for example, storage size and locations, and timing of execution of workloads.

At block 104, each workload is classified and grouped as discussed above to generate a workload model specific to the user. The workload model classifies the various workloads into workload groups, based at least on storage needs, workload type and data type, for example. The workloads may also be classified and grouped according to charge amounts (i.e., price).

At block 105, workloads are collected and the beginning plan is executed. At block 106, delta encoding data is collected, which may be delta encoding or delta-of-delta encoding data. In addition, during execution, at block 107, workload sizes and/or sizes of data records and stored data in the TSDB is collected.

At block 108, the system periodically monitors workload progress (periodic recap), which may include checking for new workloads, collecting delta parameters, estimating workload time remaining, etc. Real time adjustment of the plan may be performed at block 109.

At block 110, as part of the periodic recap, the revision model may be used to predict subsequent time series data, using fixed time windows or self-adjusted time windows as discussed above. The workload model for a tenant can then be updated using the revision model.

At block 111, as new workloads and/or tenants are received or detected, a “new coming model advisory” or other notification can be provided to the system to alert the system.

In an embodiment, as new tenants and/or workloads (or jobs) are received, they may be classified according to the workload model discussed above. For example, if a new tenant is introduced, the system will attempt to classify the new tenant and/or construct the workload model. If the new tenant can be classified and is similar to other tenants, the new tenant may be incorporated into a federated model. For example, a user classification or group, or a workload classification, can be federated into the federated model based on parameter values calculated using a parameters averaging method. An example of the averaging method is represented by the following equation:

$$\begin{matrix}{W}_{i + 1} = \frac{1}{n} {\sum }_{w = 1}^{n} {W}_{i + 1 , w} = \\ \frac{1}{n} {\sum }_{w = 1}^{n} \left({W}_{i} - \frac{α}{m} {\sum }_{j = \left(w - 1\right) m + 1}^{w m} \frac{\partial {L}^{j}}{\partial {W}_{i}}\right) = {W}_{i} - \frac{α}{n m} {\sum }_{j = 1}^{n m} \frac{\partial {L}^{j}}{\partial {W}_{i}} ,\end{matrix}$$

where W is a parameter (e.g., workload parameter), Wᵢ is a previous value of the parameter, and Wᵢ₊₁ is a current value of the parameter w is an index from one to n, where n is a number of tenants, and W_{i+1,w} is the current parameter value from each tenant.

If the new tenant is not amenable to be directly grouped into an existing tenant group, the new tenant can be compared with existing tenants based on:

$$S e {t}_{n e w} = {∪}_{\begin{matrix}i = \left(0 , 1 … M\right) , \\ j = \left(0 , 1 … N\right)\end{matrix}}^{M , N} r \left(\vec{n e w} , \vec{{D}_{i , j}}\right) ,$$

where set_{new} represents a union between a new customer (denoted as n̅e̅w̅) and existing customer group D_{i,j} that includes an existing tenant having a number M of parameter values i (e.g., workload type, traffic plan, etc.), and another existing tenant having a number N of parameter values j (e.g., workload type, traffic plan, etc.). When a new node or user is added to a network, the new node or user is compared to exiting groups and can be assigned to a group having similarities with the new node or user.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service’s provider.

Broad network access: capabilities are available over a network and accessed through standard mechanisms that promote use by heterogeneous thin or thick client platforms (e.g., mobile phones, laptops, and PDAs).

Resource pooling: the provider’s computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider’s applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

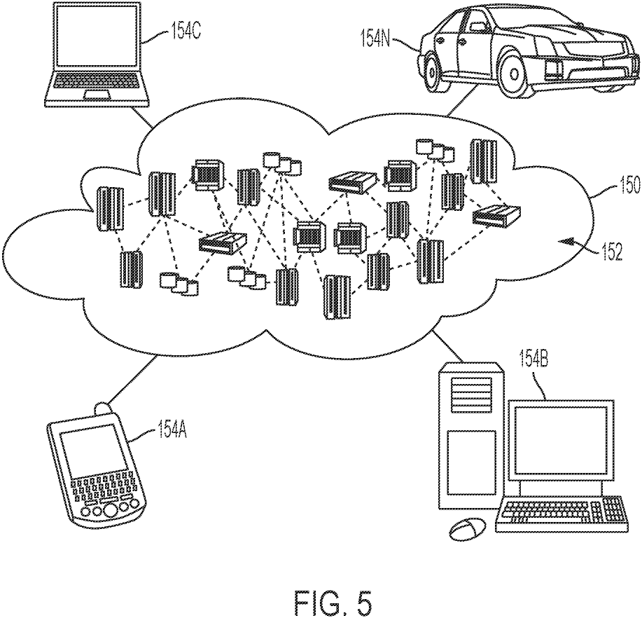

Referring now to FIG. 5, illustrative cloud computing environment 150 is depicted. As shown, cloud computing environment 150 includes one or more cloud computing nodes 152 with which local computing devices used by cloud consumers, such as, for example, personal digital assistant (PDA) or cellular telephone 154A, desktop computer 154B, laptop computer 154C, and/or automobile computer system 154N may communicate. Nodes 152 may communicate with one another. They may be grouped (not shown) physically or virtually, in one or more networks, such as Private, Community, Public, or Hybrid clouds as described hereinabove, or a combination thereof. This allows cloud computing environment 150 to offer infrastructure, platforms and/or software as services for which a cloud consumer does not need to maintain resources on a local computing device. It is understood that the types of computing devices 154A-N shown in FIG. 5 are intended to be illustrative only and that computing nodes 152 and cloud computing environment 50 can communicate with any type of computerized device over any type of network and/or network addressable connection (e.g., using a web browser).

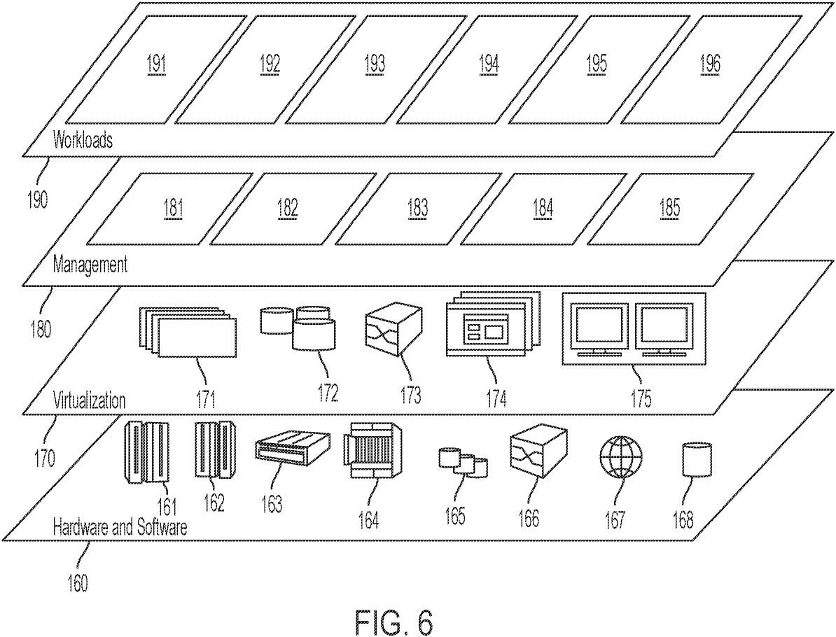

Referring now to FIG. 6, a set of functional abstraction layers provided by cloud computing environment 150 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 160 includes hardware and software components. Examples of hardware components include: mainframes 161; RISC (Reduced Instruction Set Computer) architecture based servers 162; servers 163; blade servers 164; storage devices 165; and networks and networking components 166. In some embodiments, software components include network application server software 167 and database software 168. Aspects of embodiments described herein may be embodied in one or more of the above hardware and software components.

Virtualization layer 170 provides an abstraction layer from which the following examples of virtual entities may be provided: virtual servers 171; virtual storage 172; virtual networks 173, including virtual private networks; virtual applications and operating systems 174; and virtual clients 175.

In one example, management layer 180 may provide the functions described below. Resource provisioning 181 provides dynamic procurement of computing resources and other resources that are utilized to perform tasks within the cloud computing environment. Metering and Pricing 182 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 183 provides access to the cloud computing environment for consumers and system administrators. Service level management 184 provides cloud computing resource allocation and management such that required service levels are met. Service Level Agreement (SLA) planning and fulfillment 185 provide pre-arrangement for, and procurement of, cloud computing resources for which a future requirement is anticipated in accordance with an SLA.

Workloads layer 190 provides examples of functionality for which the cloud computing environment may be utilized. Examples of workloads and functions which may be provided from this layer include: mapping and navigation 191; software development and lifecycle management 192; virtual classroom education delivery 193; data analytics processing 194; transaction processing 195; and data encryption/decryption 196.

It is understood that one or more embodiments of the present invention are capable of being implemented in conjunction with any type of computing environment now known or later developed.

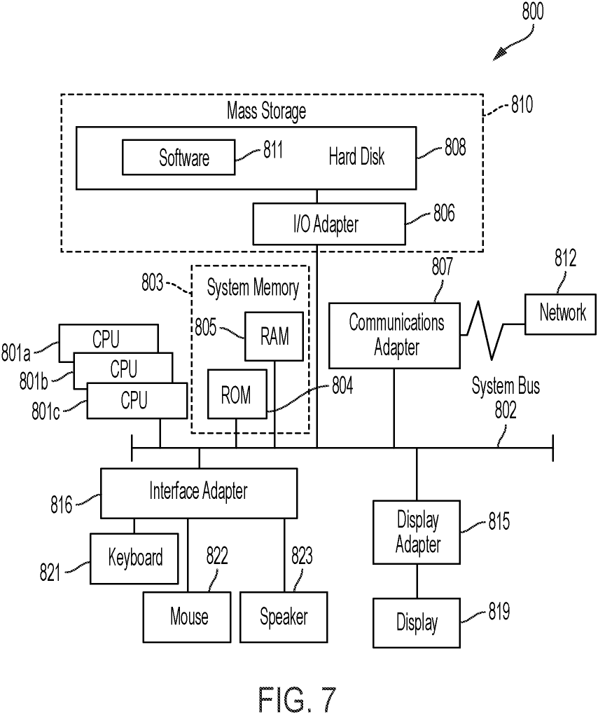

Turning now to FIG. 7, a computer system 800 is generally shown in accordance with an embodiment. All or a portion of the computer system 800 shown in FIG. 7 can be implemented by one or more cloud computing nodes 10 and/or computing devices 54A-N of FIG. 5. The computer system 800 can be an electronic, computer framework comprising and/or employing any number and combination of computing devices and networks utilizing various communication technologies, as described herein. The computer system 800 can be easily scalable, extensible, and modular, with the ability to change to different services or reconfigure some features independently of others. The computer system 800 may be, for example, a server, desktop computer, laptop computer, tablet computer, or smartphone. In some examples, computer system 800 may be a cloud computing node. Computer system 800 may be described in the general context of computer system executable instructions, such as program modules, being executed by a computer system. Generally, program modules may include routines, programs, objects, components, logic, data structures, and so on that perform particular tasks or implement particular abstract data types. Computer system 800 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 7, the computer system 800 has one or more central processing units (CPU(s)) 801a, 801b, 801c, etc. (collectively or generically referred to as processor(s) 801). The processors 801 can be a single-core processor, multi-core processor, computing cluster, or any number of other configurations. The processors 801, also referred to as processing circuits, are coupled via a system bus 802 to a system memory 803 and various other components. The system memory 803 can include a read only memory (ROM) 804 and a random access memory (RAM) 805. The ROM 804 is coupled to the system bus 802 and may include a basic input/output system (BIOS), which controls certain basic functions of the computer system 800. The RAM is read-write memory coupled to the system bus 802 for use by the processors 801. The system memory 803 provides temporary memory space for operations of said instructions during operation. The system memory 803 can include random access memory (RAM), read only memory, flash memory, or any other suitable memory systems.

The computer system 800 comprises an input/output (I/O) adapter 806 and a communications adapter 807 coupled to the system bus 802. The I/O adapter 806 may be a serial advanced technology attachment (SATA) adapter that communicates with a hard disk 808 and/or any other similar component. The I/O adapter 806 and the hard disk 808 are collectively referred to herein as a mass storage 810.

Software 811 for execution on the computer system 800 may be stored in the mass storage 810. The mass storage 810 is an example of a tangible storage medium readable by the processors 801, where the software 811 is stored as instructions for execution by the processors 801 to cause the computer system 800 to operate, such as is described herein with respect to the various Figures. Examples of computer program product and the execution of such instruction is discussed herein in more detail. The communications adapter 807 interconnects the system bus 802 with a network 812, which may be an outside network, enabling the computer system 800 to communicate with other such systems. In one embodiment, a portion of the system memory 803 and the mass storage 810 collectively store an operating system, which may be any appropriate operating system, such as the z/OS® or AIX® operating system, to coordinate the functions of the various components shown in FIG. 6.

Additional input/output devices are shown as connected to the system bus 802 via a display adapter 815 and an interface adapter 816 and. In one embodiment, the adapters 806, 807, 815, and 816 may be connected to one or more I/O buses that are connected to the system bus 802 via an intermediate bus bridge (not shown). A display 819 (e.g., a screen or a display monitor) is connected to the system bus 802 by a display adapter 815, which may include a graphics controller to improve the performance of graphics intensive applications and a video controller. A keyboard 821, a mouse 822, a speaker 823, etc. can be interconnected to the system bus 802 via the interface adapter 816, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI). Thus, as configured in FIG. 8, the computer system 800 includes processing capability in the form of the processors 801, and storage capability including the system memory 803 and the mass storage 810, input means such as the keyboard 821 and the mouse 822, and output capability including the speaker 823 and the display 819.

In some embodiments, the communications adapter 807 can transmit data using any suitable interface or protocol, such as the internet small computer system interface, among others. The network 812 may be a cellular network, a radio network, a wide area network (WAN), a local area network (LAN), or the Internet, among others. An external computing device may connect to the computer system 800 through the network 812. In some examples, an external computing device may be an external webserver or a cloud computing node.

It is to be understood that the block diagram of FIG. 7 is not intended to indicate that the computer system 800 is to include all of the components shown in FIG. 7. Rather, the computer system 800 can include any appropriate fewer or additional components not illustrated in FIG. 7 (e.g., additional memory components, embedded controllers, modules, additional network interfaces, etc.). Further, the embodiments described herein with respect to computer system 800 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discreet logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ± 8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk drive (HDD), a solid state drive (SDD), a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

1. A method of managing time series data workload requests, the method comprising:
receiving a workload job request from a user in a multi-tenant network, the request specifying a plurality of workloads, each workload including time series data configured to be stored in a time series database (TSDB);
inputting workload information to a workload model that is specific to the user, and classifying each workload according to the workload model, the workload model configured to classify each workload based on a plurality of parameters, the plurality of parameters including at least a workload type and an amount of storage associated with each workload;
assigning each workload of the plurality of workloads into one or more workload groups based on the classifying; and
executing each workload according to the workload type and the storage size.

2. The method of claim 1, wherein the workload model is further configured to classify each workload based on a charge amount associated with each workload.

3. The method of claim 1, wherein the workload model is further configured to classify each workload by defining a vector space, constructing a workload type vector and a storage size vector, and calculating a vector angle.

4. The method of claim 1, further comprising monitoring stored time series data during execution of each workload, calculating a delta value based on changes in the stored time series data, and predicting time series data values for a future time window.

5. The method of claim 4, further comprising automatically adjusting the future time window based on the predicting.

6. The method of claim 5, further comprising inputting the predicted data values to a revision model, the revision model configured to calculate a variance between one or more parameters of the stored time series data and one or more parameters of the predicted data values.

7. The method of claim 6, further comprising adjusting the workload model based on the variance.

8. The method of claim 1, further comprising incorporating the workload groups into a federated model associated with a plurality of tenants in the multi-tenant network.

9. An apparatus for managing time series data workload requests, comprising one or more computer processors that comprise:
a processing unit including a processor configured to receive a workload job request from a user in a multi-tenant network, the request specifying a plurality of workloads, each workload including time series data configured to be stored in a time series database (TSDB),
a workload model that is specific to the user and is configured to receive workload information, classify each workload based on a plurality of parameters, the plurality of parameters including at least a workload type and an amount of storage associated with each workload, and assign each workload of the plurality of workloads into one or more workload groups based on the classifying, wherein the processor is configured to execute each workload according to the workload type and the storage size.

10. The apparatus of claim 9, wherein the workload model is configured to classify each workload based on a charge amount associated with each workload.

11. The apparatus of claim 9, wherein the workload model is configured to classify each workload by defining a vector space, constructing a workload type vector and a storage size vector, and calculating a vector angle.

12. The apparatus of claim 9, wherein the processor is configured to monitor stored time series data during execution of each workload, calculate a delta value based on changes in the stored time series data, and predict time series data values for a future time window.

13. The apparatus of claim 12, wherein the processor is configured automatically adjust the time window based on the predicting.

14. The apparatus of claim 13, wherein the processor is configured to input the predicted data values to a revision model, the revision model configured to calculate a variance between one or more parameters of the stored time series data and one or more parameters of the predicted data values.

15. The apparatus of claim 14, wherein the processor is configured to adjust the workload model based on the variance.

16. The apparatus of claim 9, wherein the processor is configured to incorporate the workload groups into a federated model associated with a plurality of tenants in the multi-tenant network.

17. A computer program product comprising a storage medium readable by one or more processing circuits, the storage medium storing instructions executable by the one or more processing circuits to perform a method comprising:
receiving a workload job request from a user in a multi-tenant network, the request specifying a plurality of workloads, each workload including time series data configured to be stored in a time series database (TSDB);
inputting workload information to a workload model that is specific to the user, and classifying each workload according to the workload model, the workload model configured to classify each workload based on a plurality of parameters, the plurality of parameters including at least a workload type and an amount of storage associated with each workload;
assigning each workload of the plurality of workloads into one or more workload groups based on the classifying; and
executing each workload according to the workload type and the storage size.

18. The computer program product of claim 17, wherein the workload model is configured to classify each workload based on a charge amount associated with each workload.

19. The computer program product of claim 17, wherein the workload model is configured to classify each workload by defining a vector space, constructing a workload type vector and a storage size vector, and calculating a vector angle.

20. The computer program product of claim 17, wherein the method further comprises monitoring stored time series data during execution of each workload, calculating a delta value based on changes in the stored time series data, predicting time series data values for a future time window, and automatically adjusting the time window based on the predicting.
